(19) United States
(12) Patent Application Publication
(10) Pub. No.: US 2023/0059256 A1
(43) Pub. Date: Feb. 23, 2023

(54) HEATING ELEMENT, AEROSOL PRODUCER, AND AEROSOL ARTICLE

(71) Applicant: Shenzhen Eigate Technology Co., Ltd., Shenzhen (CN)

(72) Inventor: Tuanfang LIU, Shenzhen (CN)

(21) Appl. No.: 17/700,419

(22) Filed: Mar. 21, 2022

(30) Foreign Application Priority Data
Aug. 17, 2021 (CN) 202110941938.3
Aug. 17, 2021 (CN) 202121930739.4

(51) Int. Cl. A24F 40/46; A24F 40/51; A24F 40/20

(52) U.S. Cl. CPC A24F 40/46; A24F 40/51; A24F 40/20

(57) ABSTRACT

A heating element includes a main body. The main body includes a thermal air chamber and at least one through hole communicating with the thermal air chamber.

### CROSS-REFERENCE TO RELATED APPLICATIONS

Pursuant to 35 U.S.C. § 119 and the Paris Convention Treaty, this application claims foreign priority to Chinese Patent Application No. 202110941938.3 filed Aug. 17, 2021, and to Chinese Patent Application No. 202121930739.4 filed Aug. 17, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to the field of electronic cigarette, and more particularly, to a heating element, an aerosol article, and an aerosol producer.

Conventionally, cigarettes release an aerosol-based odor by a low-temperature heating method so that the cigarettes can be heated without combustion. As cigarettes are heated to 350° C. to 1000° C., some harmful substances are released into the air. The low-temperature heating method allows the cigarettes to generate smoke at a temperature below 300° C. while reducing the release of harmful substances from the cigarette.

Tobacco materials are usually heated through heating rods and heating plates, which may cause uneven heating of the tobacco materials. Alternatively, the heating rods are arranged around the tobacco materials, contributing to the increased heating area; however, uneven heating occurs in the middle portion of the tobacco materials, which affects a taste in the mouth of a user.

### SUMMARY

The first objective of the disclosure is to provide a heating element comprising a main body; and the main body comprises a thermal air chamber and at least one through hole communicating with the thermal air chamber.

In a class of this embodiment, the main body is in an elongated shape; and the thermal air chamber extends along the length of the main body.

In a class of this embodiment, the thermal air chamber comprises a first chamber.

In a class of this embodiment, the heating element further comprises a temperature sensor disposed in the first chamber; and the temperature sensor includes, but is not limited to, a thermistor.

In a class of this embodiment, the first chamber is surrounded by a side wall and the at least one through hole is disposed on the side wall; and the first chamber communicates with outside air of the main body through the at least one through hole.

In a class of this embodiment, the thermal air chamber further comprises a second chamber communicating with the first chamber.

In a class of this embodiment, the second chamber is surrounded by a side wall and the at least one through hole is disposed on the side wall; and the second chamber communicates with outside air of the main body through the at least one through hole.

In a class of this embodiment, the main body further comprises an elongated sheet, a first side wall, and a second side wall; the first side wall and the second side wall are disposed oppositely to each other; the first chamber is surrounded by the first side wall and/or the second side wall; and the first side wall and/or the second side wall is disposed on the elongated sheet.

In a class of this embodiment, the elongated sheet comprises a notch extending along the length of the main body; the notch is surrounded by the first side wall and the second side wall, thus forming the first chamber; and at least one of the first side wall and the second side wall is convex with respect to the elongated sheet.

In a class of this embodiment, the main body further comprises a top part and the first chamber comprises a top portion; a preset distance exists between the top part and the top portion; and the first chamber is disposed in the middle of the main body and extends along the length of the main body.

In a class of this embodiment, the main body further comprises an annular wall surrounding an annular space; the annular wall comprises a first side wall and a second side wall disposed oppositely to the first side wall; the first chamber is surrounded by the first side wall and the second side wall; and the annular space outside the first chamber defines the second chamber.

In a class of this embodiment, the main body comprises a rigid conductive material; or, the main body further comprises a rigid non-conductive material, and a conductive layer is disposed on an outer wall of the main body.

In a class of this embodiment, the main body comprises a rigid non-metallic material, and the conductive layer is further disposed on an inner wall of the thermal air chamber; the conductive layer is further disposed on a side wall surrounding the at least one through hole; and the main body further comprises a passivation layer disposed on the conductive layer.

The second objective of the disclosure is to provide an aerosol producer; the aerosol producer comprises a cavity, and the aforesaid heating element disposed in the cavity.

The third objective of the disclosure is to provide an aerosol article; the aerosol article comprises a tobacco material and the heating element disposed in the tobacco material.

The following advantages are associated with the heating element, the aerosol producer, and the aerosol article of the disclosure: the heating element comprises a thermal air chamber and at least one through hole, which increases the heating area; when a user smokes the tobacco material, the air forces the heat flow directly from the thermal air chamber to the tobacco material, thus providing uniform heating and increasing heat utilization rate.

### BRIEF DESCRIPTION OF THE DRAWINGS

FIG. 1 is a perspective view of a heating element according to Example 1 of the disclosure;

FIG. 2 is a cross-sectional view of a heating element according to Example 1 of the disclosure;

FIG. 3 is a front view of a heating element according to Example 1 of the disclosure;

FIG. 4 is a perspective view of a heating element according to Example 2 of the disclosure;

FIG. 5 is a cross-sectional view of a heating element according to Example 2 of the disclosure;

FIG. 6 is a front view of a heating element according to Example 2 of the disclosure;

FIG. 7 is a perspective view of a heating element according to Example 3 of the disclosure;

FIG. 8 is a cross-sectional view of a heating element according to Example 3 of the disclosure;

FIG. 9 is a front view of a heating element according to Example 3 of the disclosure;

FIG. 10 is a perspective view of a heating element according to Example 4 of the disclosure;

FIG. 11 is a cross-sectional view of a heating element according to Example 4 of the disclosure; and

FIG. 12 is a front view of a heating element according to Example 4 of the disclosure.

In the drawings, the following reference numbers are used: 1. Main body; 2. 10. Thermal air chamber; 101. First side wall; 102. Through hole; 103. First chamber; 104. Second chamber; 105. Notch; 106. Tube; 107. Elongated sheet; and 108. Round wall.

### DETAILED DESCRIPTION

The term “tobacco materials” used herein refers to aerosol-generating substances that can be heated to release odor, and/or nicotine, and/or smoke. The tobacco materials are solid, liquid, or semisolid. Solid tobacco materials are often cut into tobacco flakes for high air permeability, convenient assembly, and easy preparation. The tobacco materials are produced naturally or synthetically, such as e-liquid, tobacco paste, tobacco flakes, and tobacco leaves. Synthetic tobacco materials comprise glycerin, propylene glycol and nicotine. The tobacco materials can also be enclosed in a shell which comprises pore channels or decompose at high temperatures, such as microcapsules. The tobacco materials are heated to produce volatile substances and flows out of the decomposed shell or the pore channels.

The natural tobacco materials mainly comprise nicotine. The other tobacco materials mainly comprise aroma substances which can be heated and allows people to simulate smoking, thus increasing smoker's odds of quitting smoking. In certain examples, the aroma substances comprise peppermint oil. The tobacco materials further comprise other additives, such as glycerin and/or propylene glycol.

The term “aerosol article” used herein refers to a cartridge that comprises a tobacco material capable of being heated and used to generate aerosol, such as smoke. The aerosol-producing substances comprises cigarettes or cartridges, preferably, disposable products. The aerosol article is not configured to provide power to the heating element.

The term “aerosol producer” used herein refers to a device configured to provide power to the heating element.

The term “heating element” used herein refers to a device that converts electrical or electromagnetic energy into heat. The heating element is disposed in the aerosol producer or the aerosol article. The heating element can be energized to produce heat. Alternatively, the heating element is disposed in an electromagnetic field produced by a coil, so that an electric current is induced by electromagnetic induction and used to heat the heating element.

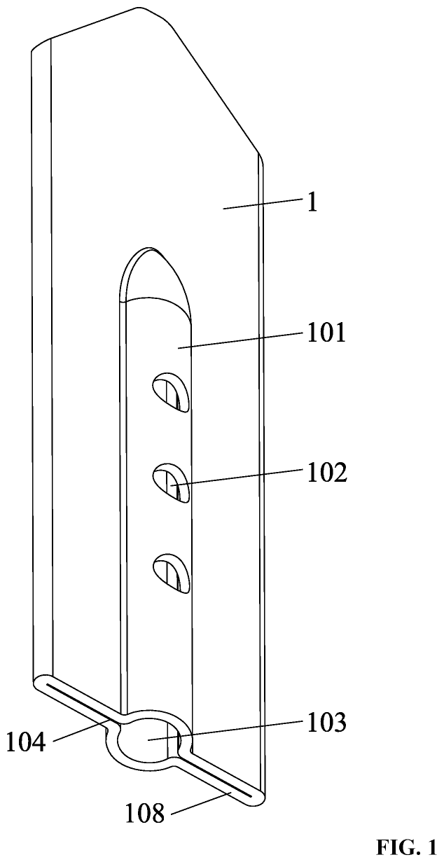

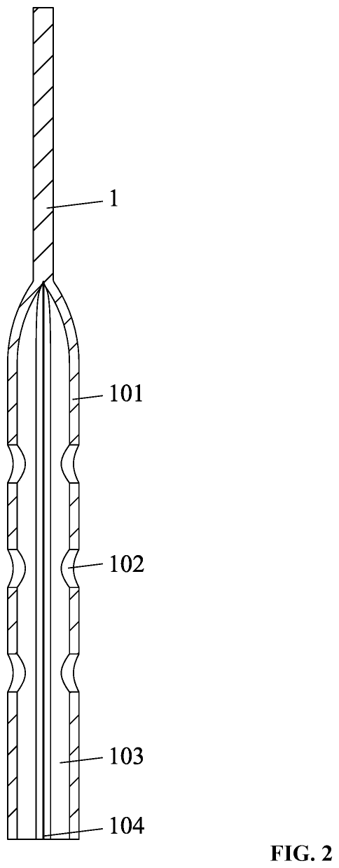

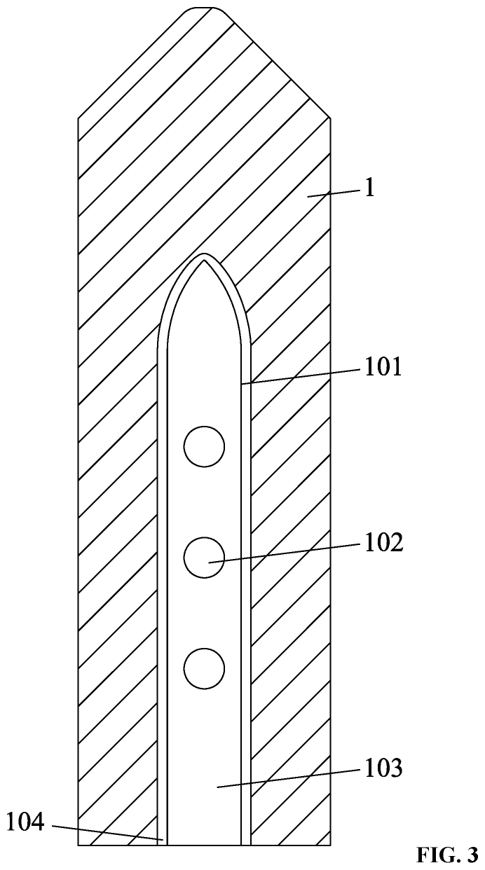

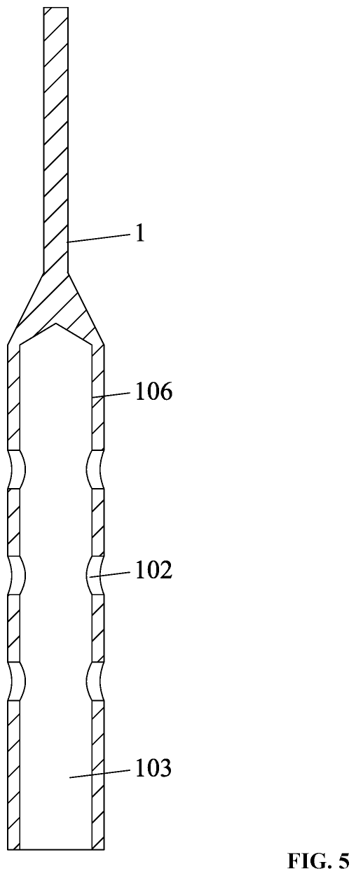

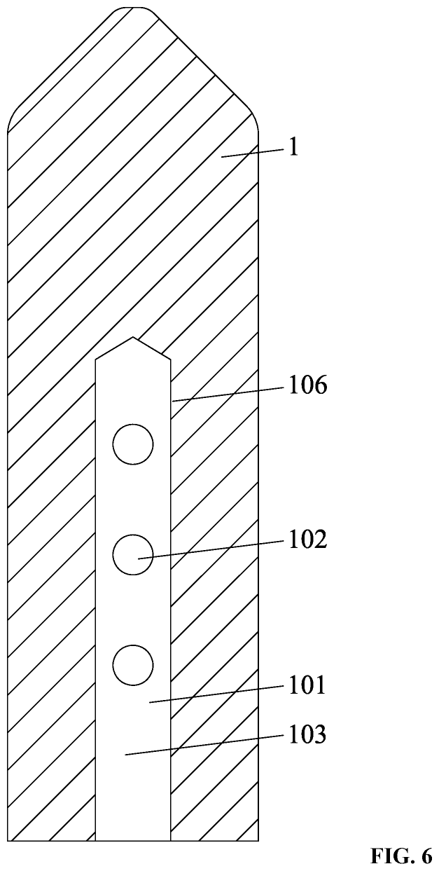

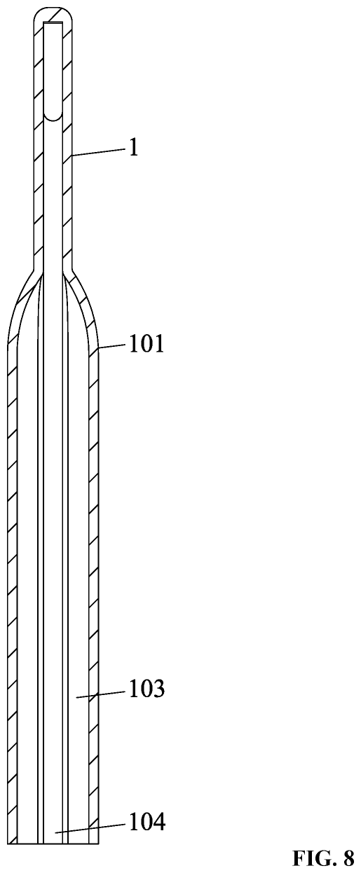

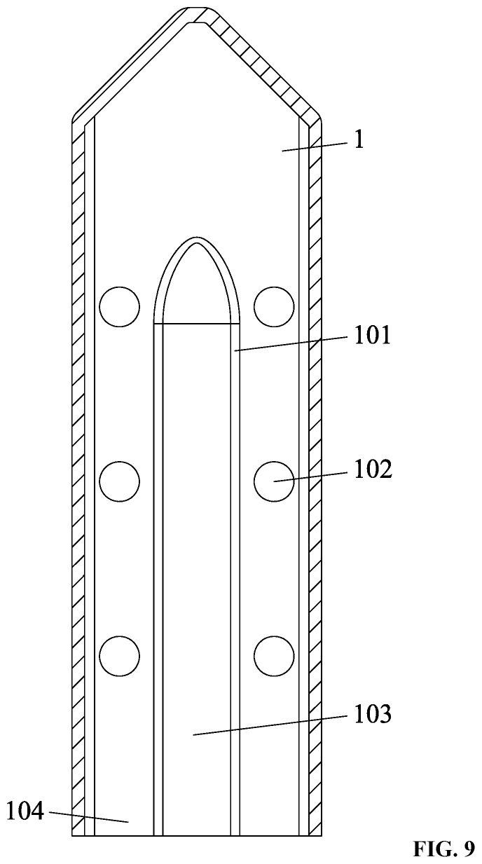

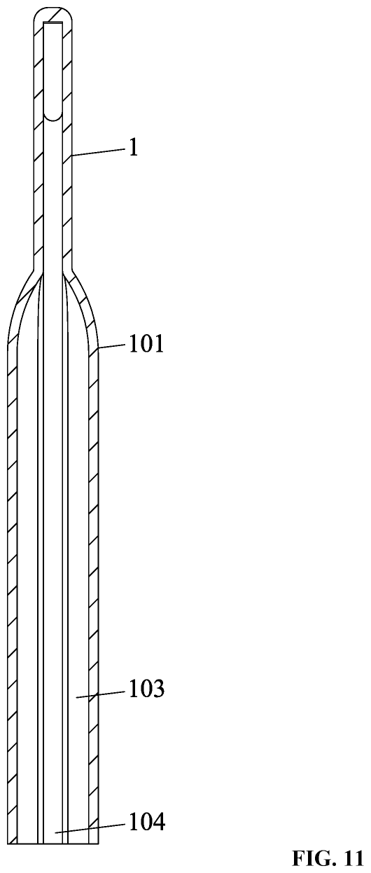

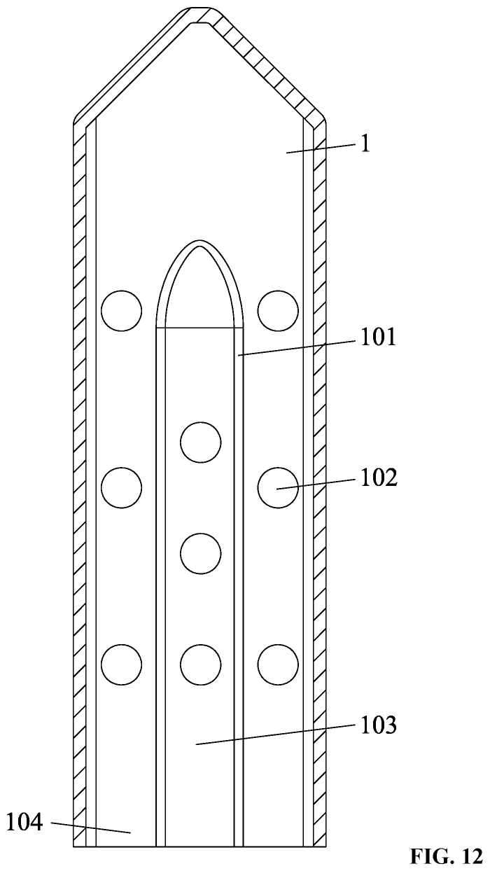

Referring to FIGS. 1-12, a heating element comprises a main body 1 provided with at least one through hole 102. The main body 1 comprises a thermal air chamber 10 communicating with the at least one through hole 102. The heating element is energized to produce heat or is heated by high-frequency electromagnetic induction. The shape of the main body 1 includes but is not limited to a sheet, and a rod. In use, the heating element is disposed in the tobacco material and energized to produce heat; alternatively, the heating element is heated by high-frequency electromagnetic induction. When a user smokes the tobacco material, air flows through the air duct of the aerosol producer into the thermal air chamber 10, thus forcing the heat directly from the thermal air chamber 10 to the tobacco material. Heat flow facilitates combustion of the tobacco material, thus increasing heat utilization rate.

In certain examples, the main body 1 comprises a rigid conductive material, such as a conductive metal and a conductive carbon material. The conductive metal includes, but is not limited to, copper, silver, gold, tungsten, aluminum, and nickel. The conductive carbon material includes, but is not limited to, carbon nanomaterials or graphene. The carbon nanomaterials comprise carbon nanotubes or carbon nanofibers.

In certain examples, the main body 1 comprises a rigid non-conductive material, including but not limited to, stainless steel, iron, titanium, chromium, and quartz. The main body 1 further comprises a conductive layer (not shown) disposed on the outer surface of the non-rigid conductive material.

In certain examples, the conductive layer is further disposed on the inner wall of the thermal air chamber 10 to increase heating area.

In certain examples, the conductive layer is further disposed on a side wall surrounding at least one through hole 102 so that the outer wall of the main body 1 is electrically connected to the inner wall of the thermal air chamber 10. In certain examples, the outer wall of the main body 1 is electrically connected to the inner wall of the thermal air chamber 10 through a conductive wire.

The conductive layer can be any shape or form including a planar shape, a mesh shape, or other shape. The conductive layer comprises a conductive metal, a carbon nanofilm, or a graphene film.

The main body further comprises a passivation layer (not shown). When the main body 1 comprises a rigid conductive material, the passivation layer is disposed on the outer wall of the main body 1 and/or the inner wall of the thermal air chamber 10 and/or the side wall of the at least one through hole 102. In certain examples, the main body 1 comprises a rigid non-conductive material coated with the conductive layer, the passivation layer is disposed on the conductive layer. Understandably, the passivation layer can be disposed on the conductive layer, and/or the outer wall of the main body 1, and/or the inner wall of the thermal air chamber 10, and/or the side wall of the at least one through hole. In certain examples, the passivation layer is disposed only on the area outside of the conductive layer; when the heating element is in the shape of a string, the passivation layer can be further disposed on the heating element. The passivation layer comprises inert metal, anti-oxidation metal, glass, glaze, ceramic, mica, quartz, agate, or a combination thereof.

In certain examples, the main body 1 is in an elongated shape and hence can be inserted into the aerosol article. The main body 1 is matched with the aerosol article in length. The thermal air chamber 10 extends along the length of the main body 1 so that the tobacco material is uniformly heated.

In certain examples, the thermal air chamber 10 comprises a first chamber 103. The first chamber 103 can be of any shape without departing from the scope and spirit of the disclosure. The first chamber 103 can be any shape or form comprising a linear shape, a curved shape, a spiral shape, or a combination thereof. Preferably, the first chamber 103 is formed into a long and narrow shape and extends along the length of the main body 1.

In certain examples, the first chamber 103 is defined by the outer wall of the main body 1 and comprises the at least one through hole 102. The at least one through hole 102 communicates with the first chamber 103 and the outside of the main body 1 to ensure that the heat is transferred through the at least one through hole 102 and is radiated to the surroundings.

In certain examples, the main body 1 comprises a top part and the first chamber 103 comprises a top portion. A preset distance exists between the top part and the top portion to prevent a mouthpiece of the aerosol article from overheating due to the heat flow. The preset distance is 2-6 mm.

In certain examples, the heating element further comprises a temperature sensor disposed in the first chamber 103. The temperature sensor is configured to measure the temperature of the heat flow rather than the heating element, thus achieving an accurate temperature control. Preferably, the first chamber 103 and the temperature sensor 5 are disposed in the middle of the main body 1 to ensure an accurate temperature measurement for the heat flow as the heat flow radiates out from the first chamber 103.

In certain examples, the thermal air chamber 10 further comprises a second chamber 104 communicating with the first chamber 103. The second chamber 104 can be of any shape without departing from the scope and spirit of the disclosure. The second chamber 104 can directly communicate with the first chamber 103 or it can be connected thereto through at least one hole or channel. In certain examples, the at least one through hole 102 is disposed on the side wall of the second chamber 104 rather than the first chamber 103; and the second chamber 104 communicates with the outside of the main body 1 through the at least one through hole 102. In certain examples, the at least one through hole 102 is disposed on the inner walls of the first chamber 103 and the second chamber 104. The second chamber 104 is configured to increase heating area and heat flow, thus providing uniform heating.

The at least one through hole 102 is disposed on or below the top portion of the first chamber 103, so that the temperature sensor is close to the at least one through hole 102, thus ensuring an accurate temperature measurement for the heat flow. A distance exists between the at least one through hole 101 and the top part of the main body 1 to reduce the heat flow into the top part of the main body 1, thus preventing a mouthpiece of the aerosol article from overheating.

### Example 1

Referring to FIGS. 1-3, the heating element comprises a main body 1 is in an elongated shape. The main body 1 comprises a sealed top end in the shape of a triangle and thus can be inserted into an aerosol article. The main body 1 further comprises a side wall 108 surrounding a space. A part of the side wall 108 is squeezed to form an elongated sheet with a protrusion part. The protrusion part comprises a first side wall 101 and a second side wall (not shown). The main body 1 further comprises a thermal air chamber 10 functioning as a first chamber 103 defined by the first side wall 101 and the second side wall. One end of the first chamber 103 is sealed with the other end opened, thus allowing the insertion of a temperature sensor into the first chamber 103. Both the first side wall 101 and the second side wall separately comprise at least one through hole 102.

### Example 2

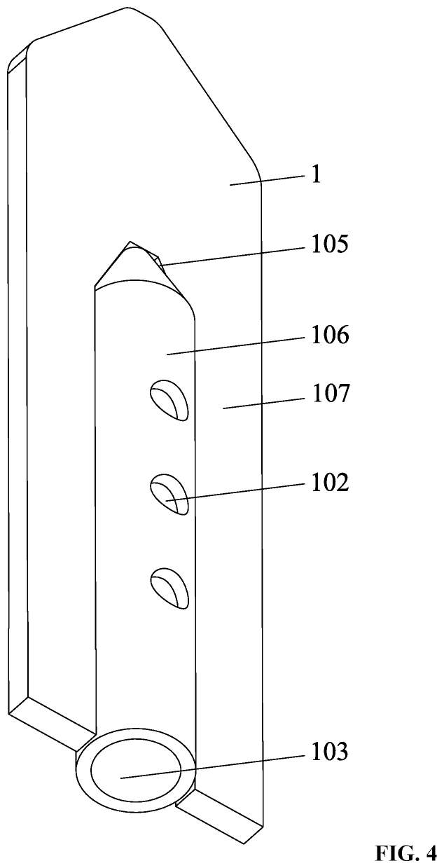

Referring to FIGS. 4-6, the heating element comprises a main body 1. The main body 1 comprises an elongated sheet 107 and a tube 106. The elongated sheet 107 comprises a top end in the shape of a triangle. One end of the tube 106 is sealed with the other end opened, thus allowing the insertion of a temperature sensor into the tube 106. The elongated sheet 107 further comprises a notch 105 extending along the length of the main body 1. The notch 105 comprises a narrow part. The tube 106 is fixedly disposed in the notch 105 with the sealed end abutting against the surface of the elongated sheet 107. The tube 106 comprises a first side wall 101 and a second side wall formed integrally with the first side wall 101. A first chamber 103 is surrounded by the first side wall 101 and the second side wall. The first side wall 101 and the second side wall are convex with respect to the elongated sheet 107. Both the first side wall 101 and the second side wall separately comprise at least one through hole 102.

### Example 3

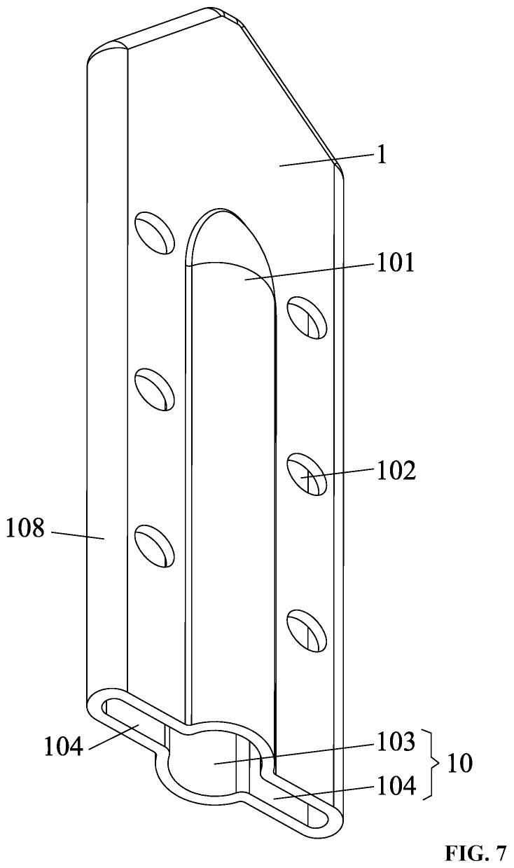

Referring to FIGS. 7-9, the heating element comprises a main body 1 is in an elongated shape. The main body 1 comprises a sealed top end in the shape of a triangle and thus can be inserted into an aerosol article. The main body 1 further comprises a side wall 108 surrounding a space. The cross-sectional of the space can be any shape including a circular shape, a square shape, or other shape. In the example, the side wall 108 surrounds the space having a cross section which conforms to a pill shape.

The space functions as a thermal air chamber 10. The thermal air chamber 10 comprises a first chamber 103 and a second chamber 104. The side wall 108 comprises a first side wall 101 and a second side wall disposed oppositely to the first side wall 101. The first chamber 103 is defined by the first side wall 101 and the second side wall. The second chamber 104 comprises a residual space outside of the first chamber 103.

A distance exists between the corresponding side edges of the first side wall and the second side wall, so that the first chamber 103 communicates with the second chamber 104. In certain examples, when both edges of the first side wall 101 are formed integrally with the corresponding edges of the second side wall or they are connected thereto, the first side wall, the second side wall, and/or a junction therebetween comprise at least one through hole, so that the first chamber 103 communicates with the second chamber 104.

The first chamber 103 comprises an open top for insertion of a temperature sensor into the first chamber 103. The other end of the first chamber 103 communicate with the second chamber 104, thus providing a uniform distribution of heat flow.

In the example, the side wall surrounding the second chamber 104 comprises at least one through hole 102. The second chamber 104 communicates with the outside of the main body through the at least one through hole 102.

### Example 4

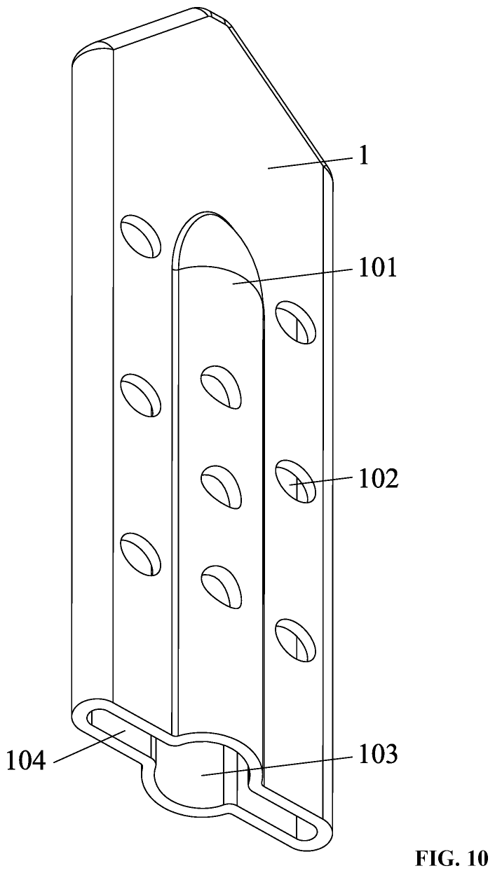

A fourth example of the heating element is illustrated in FIGS. 10-12. It is similar to Example 3, except for the following specific differences: the at least one through hole 102 is disposed on the first side wall, the second side wall, and the side wall surrounding the second chamber 104.

### Example 5

An aerosol article comprises a tobacco material and one of the heating elements of Examples 1-4. The heating element is disposed in tobacco material. The aerosol article is disposed into an aerosol producer that can generate a high-frequency electromagnetic field. The heating element is heated by high-frequency electromagnetic induction while transferring the heat to the tobacco material. In certain examples, the heating element comprises a first electrode and a second electrode; the aerosol producer comprises a battery; the battery comprises a third electrode and a fourth electrode; the first electrode and the second electrode are electrically connected to the third electrode and the fourth electrode, respectively, thus allowing the heating element to heat the tobacco material. In certain examples, the aerosol article comprises two conducting electrodes electrically connected to the heating element; the aerosol article is disposed into the aerosol producer to ensure that the two conducting electrodes are electrically connected to the third electrode and the fourth electrode, respectively; when the aerosol producer is energized, the heating element generates heat. In certain examples, the aerosol article is disposed in an electromagnetic field produced by a coil, so that an electric current is induced in the coil by electromagnetic induction and used to produce heat.

### Example 6

An aerosol producer comprises a cavity. One of the heating elements of Examples 1-4 is disposed in the cavity. In use, the aerosol article is disposed into the cavity and is heated by high-frequency electromagnetic induction to produce smoke.

It will be obvious to those skilled in the art that changes and modifications may be made, and therefore, the aim in the appended claims is to cover all such changes and modifications.

The invention claimed is:

1. A heating element, comprising a main body; wherein the main body comprises a thermal air chamber and at least one through hole communicating with the thermal air chamber.

2. The heating element of claim 1, wherein the main body is in an elongated shape; and the thermal air chamber extends along a length of the main body.

3. The heating element of claim 1, wherein the thermal air chamber comprises a first chamber.

4. The heating element of claim 3, wherein the heating element further comprises a temperature sensor disposed in the first chamber.

5. The heating element of claim 3, wherein the first chamber is surrounded by a side wall and the at least one through hole is disposed on the side wall; and the first chamber communicates with outside air of the main body through the at least one through hole.

6. The heating element of claim 3, wherein the thermal air chamber further comprises a second chamber communicating with the first chamber.

7. The heating element of claim 6, wherein the second chamber is surrounded by a side wall and the at least one through hole is disposed on the side wall; and the second chamber communicates with outside air of the main body through the at least one through hole.

8. The heating element of claim 3, wherein the main body further comprises an elongated sheet, a first side wall, and a second side wall; the first side wall and the second side wall are disposed oppositely to each other; the first chamber is surrounded by the first side wall and/or the second side wall; and the first side wall and/or the second side wall is disposed on the elongated sheet.

9. The heating element of claim 8, wherein the elongated sheet comprises a notch extending along a length of the main body; the notch is surrounded by the first side wall and the second side wall, thus forming the first chamber; and at least one of the first side wall and the second side wall is convex with respect to the elongated sheet.

10. The heating element of claim 5, wherein the main body further comprises a top part and the first chamber comprises a top portion; a preset distance exists between the top part and the top portion; and the first chamber is disposed in the middle of the main body and extends along a length of the main body.

11. The heating element of claim 7, wherein the main body further comprises a top part and the first chamber comprises a top portion; a preset distance exists between the top part and the top portion; and the first chamber is disposed in the middle of the main body and extends along a length of the main body.

12. The heating element of claim 6, wherein the main body further comprises an annular wall surrounding an annular space; the annular wall comprises a first side wall and a second side wall disposed oppositely to the first side wall; the first chamber is surrounded by the first side wall and the second side wall; and the annular space outside the first chamber defines the second chamber.

13. The heating element of claim 1, wherein the main body comprises a rigid conductive material; optionally, the main body further comprises a rigid non-conductive material, and a conductive layer is disposed on an outer wall of the main body.

14. The heating element of claim 13, wherein the main body comprises a rigid non-metallic material, and the conductive layer is further disposed on an inner wall of the thermal air chamber; the conductive layer is further disposed on a side wall surrounding the at least one through hole; and the main body further comprises a passivation layer disposed on the conductive layer.

15. An aerosol-generating device, comprising a cavity, and the heating element of claim 1 disposed in the cavity.

16. An aerosol-generating article, comprising a tobacco material and the heating element of claim 1 disposed in the tobacco material.
